(19) United States
(12) Patent Application Publication
(10) Pub. No.: US 2013/0342733 A1
(43) Pub. Date: Dec. 26, 2013

(54) Optoelectronic device and method for brightness correction

(71) Applicant: SICK AG, Waldkirch (DE)

(72) Inventors: Sascha BURGHARDT, Waldkirch (DE); Dietram RINKLIN, Waldkirch (DE); Pascal SCHULER, Waldkirch (DE); Stephan Walter, Waldkirch (DE)

(21) Appl. No.: 13/908,626

(22) Filed: Jun. 3, 2013

(30) Foreign Application Priority Data
Jun. 22, 2012 (EP) 12173210.1

(51) Int. Cl. H04N 5/235

(52) U.S. Cl. CPC H04N 5/235
USPC 348/234

(57) ABSTRACT

An optoelectronic device (10) is provided having an image sensor (20) for generating pixel images of a detection area (12) and a brightness correction unit (28) configured to modify brightness values of the pixels with a correction factor (Hₘᵤₗ) to obtain a more homogeneously illuminated image. A respective correction factor (Hₘᵤₗ) is calculated for individual pixels or groups of pixels from a perspective transformation (M) which converts geometries of an object plane (34) in the detection area (12) into geometries of the image plane (32).

The invention relates to an optoelectronic device with an image sensor for generating images of a detection area and a method for a brightness correction of such images.

In images captured by a camera, structures often have a distorted brightness distribution. This is in comparison with an imaginary or actual reference image wherein the structure is captured by an image sensor with sufficient, homogeneous illumination. In practice, numerous effects lead to deviations from the desired homogeneity, including a so-called edge decrease with a weaker illumination and detection of edge regions of an image as compared to the image center, and the emergence of brightness gradients especially in case of a large tilt of the camera with respect to the structure to be detected.

Therefore, a brightness correction or brightness normalization of the input image is often desirable. Generally speaking, the goal is to achieve the best possible realistic image capturing. Specifically, code reading it discussed as an exemplary field of application for cameras. Here, with the improvement of digital camera technology, camera-based systems increasingly replace the bar code scanners still widely used, wherein bar codes are scanned transversely to the code by a reading beam. Code readers are used, for example, at cash registers, for automated packet identification, for sorting of mail or at the baggage handling at airports, and in other logistics applications.

Instead of scanning code areas, a camera-based code reader captures images of the objects bearing the codes by means of an images sensor resolved in pixels. Subsequently, image processing software extracts the code information from these images. Camera-based code readers can easily handle other types of codes than one-dimensional bar codes, which are also two-dimensional like a matrix code and provide more information.

If the camera image which is used for the decoding comprises brightness distortions, the reading rate is affected.

A particular application for code readers is code verification. Here, other than usually, the goal is not primarily to read and process the content of the code. Instead, the quality of a code is evaluated, for example immediately after the code is printed onto or imprinted into a surface. This process may include a decoding, but the result can already be known in advance and in that case is only to be confirmed. For code quality, standards are defined, such as in ISO 6022 or ISO 15415. Effects like the distorted brightness distribution which are caused by the camera setup and the image detection situation and not by the code itself must not be included in the code verification.

According to the prior art, code readers handle a distorted brightness distribution in different ways. Often the codes are simply read without a brightness correction. However, this may lead to binarization problems in the preprocessing of the decoding. The code reading has a position-dependent component. For example, codes at an edge of the field of view are more difficult to read than those in the image centre because imaging optics and the image sensor typically have an edge energy decrease. At a strong camera tilt, the internal illumination of the code reader causes a gray value gradient or a gray value ramp in the image making the correct reading of the code information more difficult. As a result, the code reading is not equally reliable in each image region.

The code verification according to the above ISO standards is commonly done in an offline mode with correspondingly complex devices. A standard illumination is provided, and only an orthogonal view onto the code is allowed to prevent perspective distortions and to illuminate the code to be verified as homogeneous as possible. These boundary conditions are practically impossible to meet in an online application. The code reading from an orthogonal perspective is often problematic due to direct reflections of the integrated illumination. In particular for reading a code covered by a film or a code directly imprinted into a partially reflecting material, a tilted reading angle helps to reduce the influence of such reflections.

Consequently, the requirements for a code reading within an application and the code verification contradict each other. A standardized offline verification also measures the camera setup and the optical properties of the camera system from the original, unaltered image so that the verification result cannot be completely faithful to reality. It would be desirable to have a verification method of any installed camera system, directly online in the field and the application, which assists in assessing the actual physical printing or imprinting quality of the code.

If a code reading system performs a brightness correction, this is commonly done based on a mathematical model, or a calibration is performed based on a special calibration target having known brightness properties, such as a white sheet of paper. The former depends on a correct choice of model and a correct parameterization. Since there is a large number of parameters, such as the objective used, the illumination intensity of the internal illumination, its wavelength and transmission optics and the mounting angle of the camera system, which partially are not even known during manufacturing, too many parameters of the model remain unknown or uncertain, so the model becomes too complex and unmanageable. A calibration via a special calibration target, on the other hand, requires additional components and steps during setup of the code reading system.

From U.S. Pat. No. 6,758,399 B1 a distortion correction in optical code reading is known. Columns and lines of the imaged code are located, and the image is transformed so that the columns and lines are vertically or horizontally oriented, respectively. However, there is no brightness correction.

In EP 1 379 075 A, the image is corrected to compensate for the edge decrease which has been mentioned several times. To that end, pixels are brightened in accordance with their distance to central reference pixels. However, effects of perspective, i.e. deviations of the optical axis of the camera with respect to imaged object structures, are not taken into account.

It is therefore an object of the invention to provide an improved brightness correction for the images of an image sensor.

This object is satisfied by an optoelectronic device with an image sensor for generating pixel images of a detection area and with a brightness correction unit configured to modify brightness values of the pixels with a correction factor to obtain a more homogeneously illuminated image, wherein a respective correction factor is calculated for individual pixels or groups of pixels from a perspective transformation which converts geometries of an object plane in the detection area into geometries of the image plane.

The object is also satisfied by a method for brightness correction of pixel images of a detection area which are captured by an image sensor, wherein brightness values of the pixels are modified by a correction factor to obtain more homogeneously illuminated images, wherein a respective correction factor is calculated for individual pixels or groups of pixels from a perspective transformation which converts geometries of an object plane in the detection area into geometries of the image plane.

The invention starts from the basic idea that correction factors for the brightness of the individual pixels of the image can be reconstructed from the perspective distortion resulting from a non-orthogonal view of the image sensor onto the object structures. Accordingly, correction factors are calculated from a perspective transformation compensating for the tilt of the optical axis of the image sensor. The image thus corrected is brightness normalized and homogeneously illuminated, respectively, and therefore corresponds to an image that is captured in an imaginary reference situation at a normalized, homogeneous illumination and from an orthogonal view. The correction factors can be calculated during the brightness correction. However, the correction factors preferably are calculated and stored once in advance, since they depend on the device and its installation, but not on the actual scenery and the images accordingly captured. Throughout the description, preferable refers to an advantageous, but optional feature.

The invention has the advantage that neither a target specifically suitable for the purpose, such as a uniform calibration target, nor prior knowledge about the device and its mounting are required for the brightness correction. The brightness correction is completely independent of the image content and thus robust and easier to perform. Any gray scale ramp or gradient is corrected which results from the perspective position between image plane and image sensor, respectively, and object plane. The condition for a code verification that the code is to be captured from an orthogonal plan view no longer needs to be physically guaranteed with the corresponding disadvantages for example due to reflections, but is satisfied computationally afterwards. A code verification is thus possible also with a stronger camera tilt, and more generally speaking the position and orientation of the code readers can be selected independently of perspective effects and optimal for the application.

Preferably, a calibration unit is provided which is configured to determine the perspective transformation as the transformation which converts a known absolute geometry of a calibration code into its detected geometry in the image. Due to perspective distortions, the calibration code is generally not captured so that its actual geometry can be seen in the captured image. For example, a rectangular calibration code is distorted into a trapezoid. The absolute geometry, namely, the rectangular shape possibly including the aspect ratio or even the absolute dimensions, is known in advance, either by general assumptions or a parameterization. As an alternative, this geometry can be encoded into the calibration code itself so that it is known to the device by a code reading. It is thus possible to determine the required perspective transformation as that transformation which converts the detected geometry of the calibration code, i.e. for example a trapezoid, into its actual or absolute geometry, i.e. a rectangle in the example.

The calibration code does not need to have any specific properties for the brightness correction, so for example does not need to be uniformly, purely white. Therefore, a simple calibration code which can be made in the field and which is at the same time used for another calibration, for example a length calibration or an objective distortion correction. Since in principle any structure of known geometry can be used for this calibration, the device preferable has a self diagnosis to detect when the calibration is no longer correct. This is the case if a detected geometry, e.g. of a code area, does not any longer correspond to the expected absolute geometry after applying the perspective transformation. The reason could for example be that a tilt or a position of the device has changed, and the device is therefore able to ask for or immediately perform a re-calibration.

The brightness correction unit or another evaluation unit of the device preferably is configured to apply the perspective transformation on the image or a portion thereof to generate an image rectified in perspective. Thus, not only the brightness, but also the distortion as such is corrected which increases the reading rate and eliminates an interference factor for a code verification.

The brightness correction unit preferably is configured to calculate a correction factor from the ratio of the area of a partial area of the image plane to the area of a transformed partial area obtained by the perspective transformation of the partial area. Thus, a relation of original area elements of the image plane and corresponding area elements after applying the perspective transformation is evaluated. The correction factor can be directly selected as this area ratio or its reciprocal value, respectively. Alternatively, the correction factor is further modified, for example in that particularly small area ratios get a more than proportional weight to strongly brighten image regions which were especially darkened by the perspective.

The brightness correction unit preferably is configured to define the partial areas by regularly dividing the image plane, in particular into image squares. The image plane is thus covered with a grid or a grating. This results in regular partial areas in the image plane, in particular squares of a same size. The application of the perspective transformation converts these squares into trapezoids. Then, each pixel within an image square is lightened or darkened in its brightness via the correction factor to a degree corresponding to the area ratio of the square and the associated trapezoid. This compensates an energy loss due to the tilted position of the object plane, caused by the perspective of the image sensor or its tilt, respectively, by post image processing.

The brightness correction unit preferably comprises an FPGA (Field Programmable Gate Array) which multiplies the pixels of a captured image with previously stored correction factors. Here, determination of the correction factors based on the perspective transformation is done once prior to the actual operation. The correction factors are subsequently stored, for example in a lookup table. The costs for the actual brightness correction are thus reduced to a point-wise multiplication of the pixels with the corresponding correction factors. Such simple calculation tasks which are to be repeated in large number and possibly in real-time can be done particularly cost efficient with an FPGA. Alternatively, the brightness correction can be performed in software on a micro controller with sufficient computing power.

The brightness correction unit preferably is configured to perform an additional brightness correction with edge decrease correction factors which compensate a known or assumed brightness decrease of the images sensor in its edge regions. The edge decrease is thus corrected in addition to the perspective brightness distortions. Similarly, other known additional effects on the brightness distribution can be compensated in further steps. Preferably, the correction factors are merely adapted once to also consider the edge decrease or another effect so that during operation no additional effort is necessary to further improve the brightness correction.

The device preferably is configured as a camera-based code reader comprising a decoding unit to identify code areas in the images and read their encoded information. The reading rate of such a code reader is increased by the brightness correction, in particular in case of a large tilt of the code reader, i.e. a large deviation from an orthogonal plan view. The decoding unit preferably is configured for the decoding of 1D codes and 2D codes, in particular for codes comprising bars, rectangular or square module units. 1D codes usually are barcodes. Some non-exhaustive examples of common 2D codes are DataMatrix, QR codes, Aztec codes, PDF417, or MaxiCode.

The brightness correction unit preferably is configured to modify brightness values of pixels only in code areas. This reduces the computational costs.

Preferably, a code verification unit is provided which is configured to determine whether a detected code has a predetermined code quality. By the brightness correction and possibly a perspective distortion correction based on the known perspective transformation, important requirements for the standardized conditions of a code verification are also met under application conditions.

Preferably, a distance measurement unit is provided, in particular according to the light time of flight principle, to determine the distance to a code which has been read or an object which has been detected. Such distance measurements are often used for an auto focus adjustment. Thus, in addition to the two dimensions of the images, also the third dimension of the reading distance is available so that the perspective transformation and the required brightness correction can be determined and applied with even more accuracy.

The inventive method can be modified in a similar manner and shows similar advantages. Such advantageous features are described in the sub claims following the independent claims in an exemplary, but non-limiting manner.

The invention will be explained in the following also with respect to further advantages and features with reference to exemplary embodiments and the enclosed drawing. The Figures of the drawing show in:

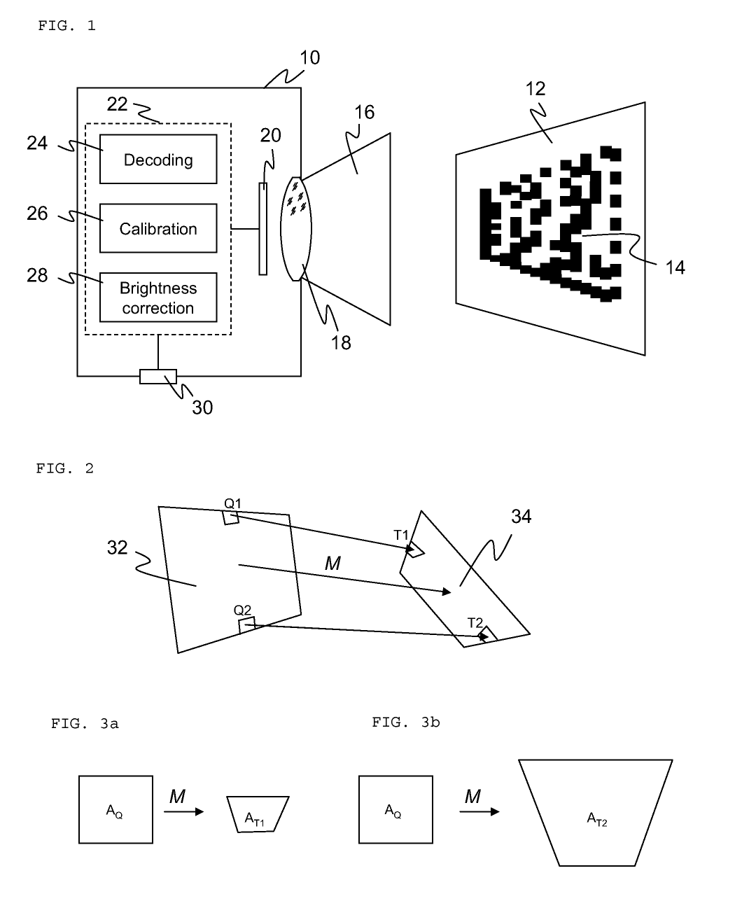

FIG. 1 a schematic sectional view of a camera-based code reader;

FIG. 2 a schematic view of the perspective transformation between object plane and image plane; and

FIG. 3a-b a schematic view of the transformation of an image square of the image plane onto a smaller or larger trapezoid in the object plane, respectively.

FIG. 1 shows a schematic sectional view of a camera-based code reader 10. The code reader 10 captures images from a detection area 12 in which arbitrary objects having geometric structures, and in particular codes 14, can be positioned. Although the invention is described using the example of the code reader 10, the brightness correction can also be applied to images of other cameras and generally of image sensors which provide a pixel image.

The light from the detection area 12 is received through an imaging objective 16, where the receiving optics are represented by only one illustrated lens 18. An image sensor 20, for example a CCD or a CMOS chip, having a plurality of pixel elements arranged in a line or a matrix, generates image data of the detection area 12 and forwards them to an evaluation unit marked as a whole with reference numeral 22. For an improved detection of the code 14, the code reader 10 may be equipped with an active illumination which is not shown.

The evaluation unit 22 is implemented on one or more digital components, such as microprocessors, ASICs (Application Specific Integrated Circuit), FPGAs, or the like, which may also be completely or partially provided external to the code reader 10. What is shown are not the physical, but the functional modules of the evaluation unit 22, namely, a decoding unit 24, a calibration unit 26, and a brightness correction unit 28.

The decoding unit 24 is configured to decode codes 14, i.e. to read the information contained in the codes 14. FIG. 1 shows a DataMatrix code as an example. However, other one-dimensional or two-dimensional types of codes can also be processed as long as corresponding reading methods are implemented in the decoding unit 24. The decoding can be preceded by a preprocessing during which regions of interest (ROI) with codes expected or detected therein are identified within the images of the image sensor 20, the images are binarized, or the like.

The calibration unit 26 is used for a calibration of the code reader 10, wherein mainly a detection and correction of a perspective and in particular an inclination or a tilt (skew) of the image sensor 20 with respect to an object plane of the code 14 is relevant. Determination of an appropriate perspective transformation M is explained in more detail below with reference to FIG. 2.

The brightness correction unit 28 adapts the brightness values of the pixels of the image captured by the image sensor 20, which is also described in more detail below with reference to FIGS. 3a-b.

At an output 30 of the code reader 10, data can be output, both read code information and other data, for example image data in various processing stages, such as raw image data, preprocessed image data, or code image data from regions of interest which have not yet been decoded.

The code reader 10 can also handle situations where the orientation is not orthogonal, in other words where the optical axis of the image sensor 20 includes a non-zero angle with respect to a normal onto an object plane of the code 14 to be read. Such tilted or skewed orientation of the code reader 10 can be desirable due to the structural conditions of the application, the goal to read codes 14 from all directions, or for example also to not reflect too much light back into the image sensor 20 from glossy surfaces. However, perspective distortions are introduced which also cause an inhomogeneous brightness distribution or gray value gradients in the image and thus affect the reading rate or, for a code verification, violate the standardized conditions.

FIG. 2 illustrates purely by way of example the image plane 32 of the image sensor 20 and the object plane 34 of the code 14 for a given orientation of code reader 10 and code 14. In general, image plane 32 and object plane 34 are not mutually parallel, and the corresponding tilt or skew angle of the code reader 10 with respect to the object plane 34 introduces a perspective distortion.

In a calibration, a matrix M and its inverse, respectively, can be determined which transforms geometries of the image plane 32 into geometries of the object plane 34. To that end, for example, an arbitrary rectangular code is presented as a calibration code. Other geometries of the calibration code are likewise possible, as long as the calibration unit 26 knows this geometry or is informed by reading a corresponding code content of the calibration code.

By reading the calibration code in the decoding unit 24, the position of the four corner points of the calibration code 100 are known with great accuracy. In the calibration unit 26, a transformation is calculated, for example by means of the transformation matrix M, which converts the corner points of the imaged, distorted calibration code into the actual geometry of a rectangle. The transformation matrix M is a perspective transformation which may include a rotation, a translation, and a rescaling. In case that the absolute dimensions of the calibration code are known, the transformation is to scale. These dimensions may be predefined, parameterized, or read from the code content of the calibration code, which may for example include a plain text with its dimensions: “calibration code, rectangular, 3 cm by 4 cm”. Without such additional information, the absolute dimensions remain an unknown scale factor of the matrix M.

The transformation M which is determined once during the calibration process is only valid as long as the code reader 10 remains in its perspective with respect to the codes 14 to be read. By using an arbitrary code 14 as a calibration code during operation, it can be checked whether the calibration is still correct. To that end, the transformation M is applied to a code 14, and it is checked whether its corner points still form a rectangle as expected.

Due to the calibration, a perspective transformation M is thus known which determines how an arbitrary geometry in the object plane 34, i.e. a planar surface from which the calibration code has been read, is mapped or imaged in the image plane 32, and vice versa. This knowledge can be used in addition to the brightness correction yet to be described to rectify image regions with codes 14 in perspective and thus increase the reading rate, or to establish standardized conditions for a code verification. Of course, the perspective transformation M can alternatively be input, or be calculated based on a model from parameters to be set, such as the skew angle of the code reader 10 and the orientation of the object plane 34.

The perspective transformation M is now used for a brightness correction. A basic idea is to conceptually regard the image plane 32 as a homogeneous surface emitter which irradiates the object plane 34, and to consider the photon distribution in an area of the object plane 34. This surface emitter is divided into squares of a same size with area A_{Q}, where FIG. 2 shows two exemplary such squares Q1 and Q2. The perspective transformation M provides, for each geometry of the imaging plane and thus also for the squares Q1 and Q2, the corresponding geometry in the object plane 34, namely, trapezoids T1 and T2.

Depending on where the square Q1, Q2 is located in the image plane 32, a trapezoid T1, T2 of different size is generated as a partial area of the object plane 34. This is schematically shown in FIGS. 3a-b once for the case of a smaller trapezoid with area A_{T1}, and once for the case of a larger trapezoid with area A_{T2}.

The squares Q1, Q2 in the image plane 32 are mutually equal in size and correspond, in the imaginary consideration of the image plane 32 as a surface emitter, to a same amount of emitted energy or photons in the direction of object plane 34. In a slight simplification, one can assume that the complete emitted energy arrives in the object plane 34. The number of photons impinging on a trapezoid T1, T2 of the object plane 34 per unit time thus only depends on the area of the trapezoids T1, T2. If the area of the trapezoid T1, T2 is larger than the original area of the square Q1, Q2, the same number of photons is distributed over a larger area so that the object plane surface is darker than the image plane square. Accordingly, for a smaller area of the trapezoid T1, T2 there is a greater photon density, such an area thus has to appear brighter.

This relationship between brightness and area ratios of the image plane 32 and the object plane 34 is used by the brightness correction unit 28. According to the model consideration, it is sufficient to use the area ratios of the square Q1, Q2 to the trapezoid T1, T2 generated by the perspective transformation M as correction factors for a brightness correction. These correction factors can for example directly be multiplied pixel-wise with the gray values of the input image supplied by the image sensor 20 in order to obtain the brightness-corrected image.

Expressed formally, for an image plane square Q at position x, y with area A_{Q(X, Y)}, a trapezoid T with area A_{T(x, y)} is generated by the transformation, and the correction factor to be multiplied for the pixels contained in the image plane square Q and their gray value, respectively, is calculated by Hₘᵤₗ=A_{Q(x, y)}/A_{T(x, y)}. The smaller the area of the square Q in the image plane 32 is selected, i.e. the fewer pixels are processed in a group with a common correction factor, the smoother will the brightness correction be.

Once the matrix M is determined during the calibration, the correction factors can also be calculated based thereon. Then, the brightness correction itself is merely a point-wise multiplication with constants. Particularly for the latter operation, implementation of the brightness correction unit 28 on an FPGA is useful, which calculates the multiplications in real-time for example based on a lookup table, and thereby assists a core CPU of the evaluation unit 22.

In order to correct further brightness distortions, for example an edge decrease due to the imaging objective 16, another correction model may additionally be applied. Therefore, another brightness correction takes place in a second step, or the correction factors discussed above are modified to also take an edge decrease or other effects into account.

1. An optoelectronic device (10) with an image sensor (20) for generating pixel images of a detection area (12) and with a brightness correction unit (28) configured to modify brightness values of the pixels with a correction factor (Hₘᵤₗ) to obtain a more homogeneously illuminated image,
characterized in that
a respective correction factor (Hₘᵤₗ) is calculated for individual pixels or groups of pixels from a perspective transformation (M) which converts geometries of an object plane (34) in the detection area (12) into geometries of the image plane (32).

2. The device (10) according to claim 1,
wherein a calibration unit (26) is provided which is configured to determine the perspective transformation (M) as the transformation which converts a known absolute geometry of a calibration code into its detected geometry in the image.

3. The device (10) according to claim 1,
wherein the brightness correction unit (28) is configured to calculate a correction factor (Hₘᵤₗ) from the ratio (A_{Q1}, A_{Q2}) of the area of a partial area (Q₁, Q₂) of the image plane (32) to the area (A_{T1}, A_{T2}) of a transformed partial area (T1, T2) obtained by the perspective transformation (M) of the partial area (Q1, Q2).

4. The device (10) according to claim 3,
wherein the brightness correction unit (28) is configured to define the partial areas (Q) by regularly dividing the image plane (32).

5. The device (10) according to claim 4,
wherein the image plane is divided into image squares.

6. The device (10) according to claim 1,
wherein the brightness correction unit (28) comprises an FPGA which multiplies the pixels of a captured image with previously stored correction factors (Hₘᵤₗ).

7. The device (10) according to claim 1,
wherein the brightness correction unit (28) is configured to perform an additional brightness correction with edge decrease correction factors which compensate a known or assumed brightness decrease of the images sensor (20) in its edge regions.

8. The device (10) according to claim 1,
wherein the device is configured as a camera-based code reader (10) comprising a decoding unit (24) to identify code areas (14) in the images and read their encoded information.

9. The device (10) according to claim 8,
wherein the brightness correction unit (28) is configured to modify brightness values of pixels only in code areas (14).

10. The device (10) according to claim 8,
wherein a code verification unit (22) is provided which is configured to determine whether a detected code (14) has a predetermined code quality.

11. A method for brightness correction of pixel images of a detection area (12) which are captured by an image sensor (20), wherein brightness values of the pixels are modified by a correction factor (Hₘᵤₗ) to obtain more homogeneously illuminated images,
characterized in that a respective correction factor (Hₘᵤₗ) is calculated for individual pixels or groups of pixels from a perspective transformation (M) which converts geometries of an object plane (34) in the detection area (12) into geometries of the image plane (32).

12. The method according to claim 11,
wherein the perspective transformation (M) is determined in a calibration process by capturing an image of a calibration code in the detection area (12) and determining that perspective transformation (M) which converts a known absolute geometry of a calibration code into its detected geometry in the image.

13. The method according to claim 11,
wherein a correction factor (Hₘᵤₗ) is calculated from the ratio (A_{Q1}, A_{Q2}) of the area of a partial area (Q1, Q2) of the image plane (32) to the area (A_{T1}, A_{T2}) of a transformed partial area (T1, T2) obtained by the perspective transformation (M) of the partial area (T1, T2).

14. The method according to claim 13,
wherein the image plane (32) is divided into partial areas being image squares (Q) of a mutually same size, and wherein the correction factor (Hₘᵤₗ) is determined from the ratio of the area (A_{Q}) of an image square (Q) to the area (A_{T1}, A_{T2}) of that trapezoid (T1, T2) into which the image square (Q9 is converted in the object plane (34) by applying the perspective transformation (M).

15. The method according to claim 11,
wherein the correction factors (Hₘᵤₗ) include an additional component by which a known or assumed brightness decrease of the image sensor (20) in its edge regions is compensated.

16. The method according to claim 11,
wherein code areas (14) in the images are identified and the information encoded therein is read.
